(19) United States
(12) Patent Application Publication
(10) Pub. No.: US 2015/0293232 A1
(43) Pub. Date: Oct. 15, 2015

(54) System and Method for Compressing GPS Data

(71) Applicant: NeoTerra Systems Inc., Orangeville (CA)

(72) Inventors: Ewan CRAWFORD, Erin (CA); Thomas BEHAN, Cobourg (CA); Daniel KELLY, Moorefield (CA)

(21) Appl. No.: 14/640,179

(22) Filed: Mar. 6, 2015

Related U.S. Application Data
(60) Provisional application No. 61/979,781, filed on Apr. 15, 2014.

(51) Int. Cl. G01S 19/06

(52) U.S. Cl. CPC G01S 19/06

(57) ABSTRACT

A system and method are provided for compressing global positioning system (GPS) data. The method includes determining a first GPS position and an associated first time; incorporating the first GPS position and the associated first time in a GPS update packet; determining a time interval for a set of GPS positions subsequent to the first GPS position and specifying the time interval in the GPS update packet; and for each of the set of GPS positions subsequent to the first GPS position: computing a relative latitude value and a relative longitude value; compressing the relative latitude and longitude values by reducing precision; and storing compressed relative latitude and longitude values in the GPS update packet. There is also provided a system and method for decompressing such compressed global positioning system (GPS) data.

This application claims priority to U.S. Provisional Patent Application No. 61/979,781 filed on Apr. 15, 2014, the contents of which are incorporated herein by reference.

### TECHNICAL FIELD

The following relates to systems and methods for compressing global positioning system (GPS) data.

### DESCRIPTION OF THE RELATED ART

For many wireless networks, bandwidth is an important and often expensive and/or scarce resource. This is particularly true for networks such as those used by commercial or consumer radios, satellite services, and the like. While in most circumstances it is sufficient to reduce the number of transmissions, e.g., by reducing overhead, concatenating messages, only transmitting when necessary, etc.; these techniques are not always desirable or sufficient in all cases.

For example, when tracking the position of a vehicle, a large number GPS updates is typically required to provide sufficient resolution in the time dimension for vehicles operating at common speeds (e.g., defined as 0 km/h to 160 km/h or 0 mph to 100 mph). Vehicles travelling at these velocities require frequent updates to ensure that the distance covered between each update is not so large as to be unviable for a variety of applications. As such, an ability to transmit a vehicle's position with a relatively high resolution in both time and space, while at the same time minimizing bandwidth consumption is considered desirable.

### SUMMARY

A system is described below, which can allow the transmission of frequent location updates on systems with limited resources and still provide the fully range of spatial information to determine not only position, but azimuth and velocity as well as accurate time information of the sample.

In one aspect, there is provided a method of compressing global positioning system (GPS) data, the method comprising: determining a first GPS position and an associated first time; incorporating the first GPS position and the associated first time in a GPS update packet; determining a time interval for a set of GPS positions subsequent to the first GPS position and specifying the time interval in the GPS update packet; and for each of the set of GPS positions subsequent to the first GPS position: computing a relative latitude value and a relative longitude value; compressing the relative latitude and longitude values by reducing precision; and storing compressed relative latitude and longitude values in the GPS update packet.

In another aspect, there is provided a computer readable medium comprising computer executable instructions for compressing global positioning system (GPS) data, the computer executable instructions comprising instructions for: determining a first GPS position and an associated first time; incorporating the first GPS position and the associated first time in a GPS update packet; determining a time interval for a set of GPS positions subsequent to the first GPS position and specifying the time interval in the GPS update packet; and for each of the set of GPS positions subsequent to the first GPS position: computing a relative latitude value and a relative longitude value; compressing the relative latitude and longitude values by reducing precision; and storing compressed relative latitude and longitude values in the GPS update packet.

In yet another aspect, there is provided a system for compressing global positioning system (GPS) data, the system comprising a processor and memory, the memory comprising computer executable instruction executable to: determine a first GPS position and an associated first time; incorporate the first GPS position and the associated first time in a GPS update packet; determine a time interval for a set of GPS positions subsequent to the first GPS position and specifying the time interval in the GPS update packet; and for each of the set of GPS positions subsequent to the first GPS position: compute a relative latitude value and a relative longitude value; compress the relative latitude and longitude values by reducing precision; and store compressed relative latitude and longitude values in the GPS update packet.

In yet another aspect, there is provided a method of decompressing compressed global positioning system (GPS) data, the method comprising: receiving a GPS update packet, the GPS update packet comprising a first GPS position, an associated first time, a time interval, and a set of GPS positions subsequent to the first GPS position, each of the set of GPS positions subsequent to the first GPS position comprising a relative latitude value and a relative longitude value, the relative latitude and longitude values having been compressed by reducing precision; and for each of the set of GPS positions subsequent to the first GPS position: computing a full GPS positions using the relative latitude and longitude values and a previous GPS position; and associating a time with the full GPS positions according to the time interval.

In yet another aspect, there is provided a computer readable medium comprising computer executable instructions for decompressing global positioning system (GPS) data, the computer executable instructions comprising instructions for: receiving a GPS update packet, the GPS update packet comprising a first GPS position, an associated first time, a time interval, and a set of GPS positions subsequent to the first GPS position, each of the set of GPS positions subsequent to the first GPS position comprising a relative latitude value and a relative longitude value, the relative latitude and longitude values having been compressed by reducing precision; and for each of the set of GPS positions subsequent to the first GPS position: computing a full GPS positions using the relative latitude and longitude values and a previous GPS position; and associating a time with the full GPS positions according to the time interval.

In yet another aspect, there is provided a system for decompressing global positioning system (GPS) data, the system comprising a processor and memory, the memory comprising computer executable instruction executable to: receive a GPS update packet, the GPS update packet comprising a first GPS position, an associated first time, a time interval, and a set of GPS positions subsequent to the first GPS position, each of the set of GPS positions subsequent to the first GPS position comprising a relative latitude value and a relative longitude value, the relative latitude and longitude values having been compressed by reducing precision; and for each of the set of GPS positions subsequent to the first GPS position: compute a full GPS positions using the relative latitude and longitude values and a previous GPS position; and associate a time with the full GPS positions according to the time interval.

### BRIEF DESCRIPTION OF THE DRAWINGS

Embodiments will now be described by way of example only with reference to the appended drawings wherein:

FIG. 1 is a schematic diagram of a location tracking system;

FIG. 2 is a block diagram illustrating an example of a configuration for a location tracking client device;

FIG. 3 is a block diagram illustrating an example of a configuration for a location tracking server device;

FIG. 4 is a schematic diagram illustrating a location update packet, including a schematic illustration of compressed GPS updates contained in the update packet;

FIG. 5 is a flow chart illustrating computer executable instructions for generating a location update packet having compressed GPS updates;

FIG. 6 is a flow chart illustrating computer executable instructions for generating a location update packet provided to a client device;

FIG. 7 is a flow chart illustrating computer executable instructions for compressing GPS updates to be included in a location update packet; and

FIG. 8 is a flow chart illustrating computer executable instructions for decoding a received location update packet.

### DETAILED DESCRIPTION

It has been found that by using relative location measurements and removing some precision, the number of GPS updates included in a single update packet can be increased.

For example, using the compression technique described below, up 105 64 bit GPS positions can be recorded and provided in a single update packet. The compression technique saves a first GPS location into a data structure. The delta between all subsequent GPS latitudes (32 bits) and the first location is then calculated. The resulting deltas are bit shifted (e.g., two places to the right), and a truncation is performed, e.g. wherein only the first (i.e. least significant) 16 bits are saved. These 16 bits represent a reduced precision delta between two adjacent GPS latitudes. The process is repeated for longitude (i.e. on the 32 bit longitudinal readings). By reducing the all but the first GPS position from 64 bits to 32 bits a significant amount of bandwidth can be saved. The loss of accuracy from two least significant bits being bit shifted is less than the accuracy lost due to radio placement inside the vehicle. In other words, the loss of accuracy is at least roughly equivalent to inherent inaccuracy reducing the effects on the overall usability of the data, e.g., makes the resulting GPS positions of sufficient accuracy for vehicle tracking.

The solution presented herein is thus to calculate a vehicle's current position relative to its previous position at a consistent time interval. To do this, the vehicle's complete GPS coordinates are transmitted along with a timing interval to be used for each successive coordinate update. In this way, the full GPS position and time are not needed to maintain accurate information about the vehicle's location for the successive updates.

The time interval used can be chosen to be specific to each batch of positional updates and can change according to the vehicle's velocity and the requirements of the application. Additional information may be included in the compressed packet structure, again according to the requirements of the application. A bit-mask can be used to identify which additional fields are included in the packet and thus available for associated processing and use.

The following compression technique can also be applied to send GPS coordinates from a tracking server or third party service to the device or vehicle reporting its location. For example, such functionality can be used to send way-points, polygons, and other GPS based information used by the device to determine locations of interest. Similarly, the technique described herein can be used bi-directionally for any two objects or vehicles that wish to receive location-based updates about each other (e.g., two moving vehicles in a fleet).

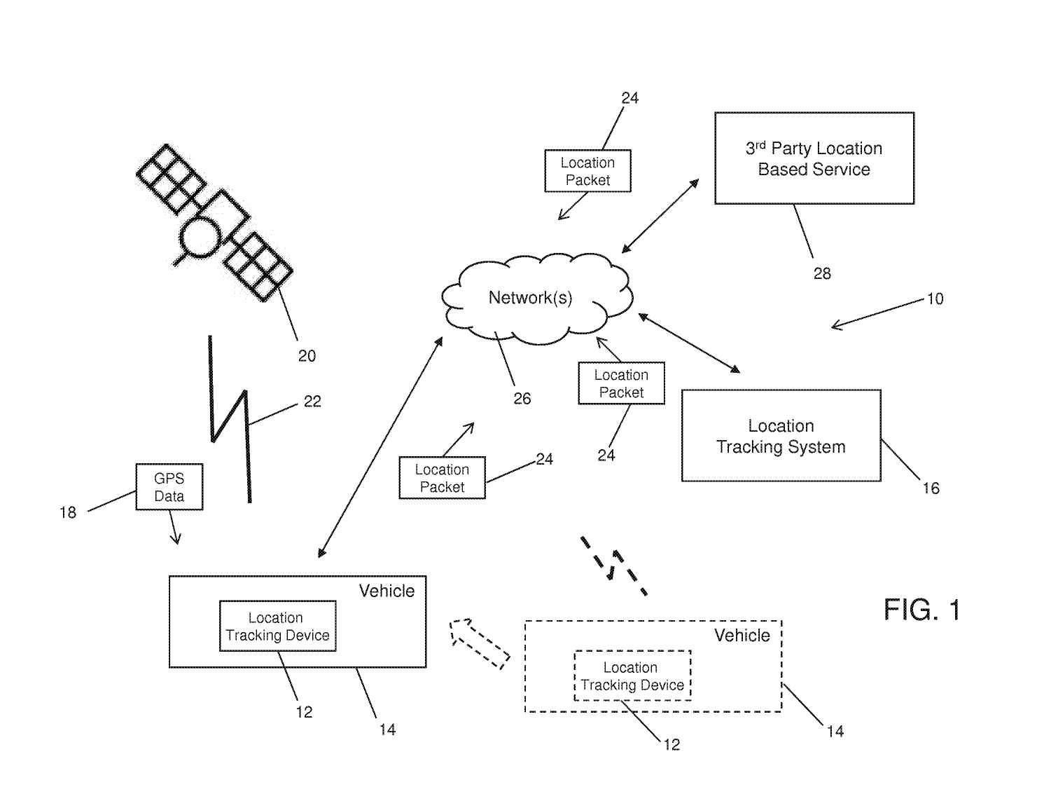

Turning now to the figures, FIG. 1 illustrates a location tracking system 10 in which a location tracking device 12 is used to report the location of a vehicle 14 as that vehicle 14 moves (as illustrated in dashed lines in FIG. 1). The vehicle 14 can be any moving object for which location tracking is desired. For example, the vehicle 14 can be a truck, van, automobile, military vehicle, or other land-based vehicle, a drone or other airborne vehicle, a ship or other watercraft, etc. The location tracking device 12 can be integral to the vehicle 14 (e.g., as part of an infotainment or navigation system) or can be a separate device (e.g., a handheld device, installed unit, etc.).

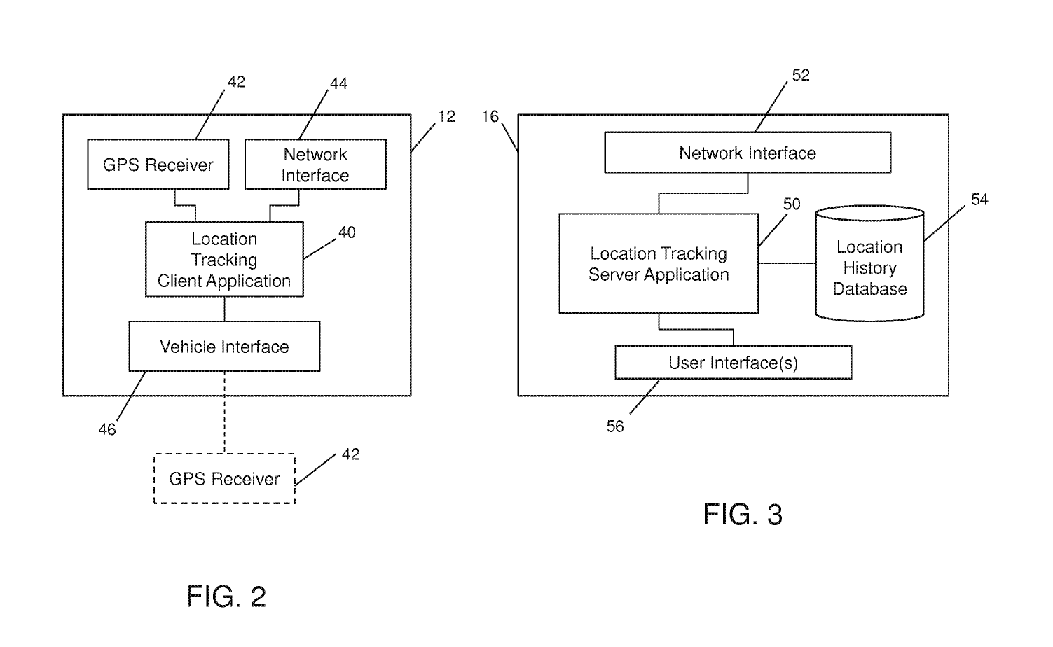

The vehicle 14 and/or location tracking device 12 includes or otherwise has access to GPS data 18 via a GPS receiver 42 (see FIG. 2). The GPS data 18 is generated by a GPS network 22 that includes a series of GPS satellites 20 and other network infrastructure not shown for ease of illustration. The location tracking device 12 includes network connectivity, or relies on network connectivity of the vehicle 14 in order to transmit a location packet 24 over one or more networks 26 to a location tracking system 16. The networks 26 can be any one or more landline or wireless networks utilized in order to enable location tracking device 12 to communicate with the location tracking system 16. For example, the network 26 can be a commercial or consumer radio network, e.g. for two-way radios, fleet tracking, etc. However, it can be appreciated that the compression technique described herein can also be adapted to be used in other networks 26 such as cellular networks.

As illustrated in FIG. 1, the location tracking system 16 and/or a 3^{rd} party location based service 28 can also be configured to generate location packets 24 that can be sent to the location tracking device 12, e.g., to be used by the vehicle's navigation system.

FIG. 2 illustrates an example of a configuration for the location tracking device 12. As mentioned above, the location tracking device 12 includes or otherwise has access to a GPS receiver 42 for obtaining GPS coordinates associated with the vehicle 14 from the GPS network 22. As illustrated in FIG. 2, the GPS receiver 42 can be an integral component or may be accessible to the location tracking device 12 via a vehicle interface 46, e.g., to a vehicle navigation system (not shown). The location tracking device 12 includes a location tracking client application 40 that obtains GPS coordinates from the GPS receiver 42 and provides location updates to the location tracking system 16 using a network interface 44 that is configured to access the one or more networks 26.

FIG. 3 illustrates an example of a configuration for a device such as a server used by the location tracking service 16 (commonly referred to hereinafter as the “location tracking service 16”). The location tracking service 16 includes a location tracking server application 50 for receiving and decoding the location packet 24. The decoded data can be stored in a location history database 54 and the location tracking server application 50 can provide data to a user interface 56, e.g., to illustrate updated locations overlaid on a map or other graphical user interface. The location tracking server application 50 receives the location packets 24 from the location tracking device 12 via a network interface 52. It can be appreciated that the frequency at which the location packets 24 are received will typically depend on the application and type of network 26 being used. For example, some commercial radio networks require 3 seconds to transmit a position packet. If only a single communication path is available for the data, then only 20 updates can be sent in a minute, thus requiring reporting intervals to be less frequent in order to support larger numbers of subscribers.

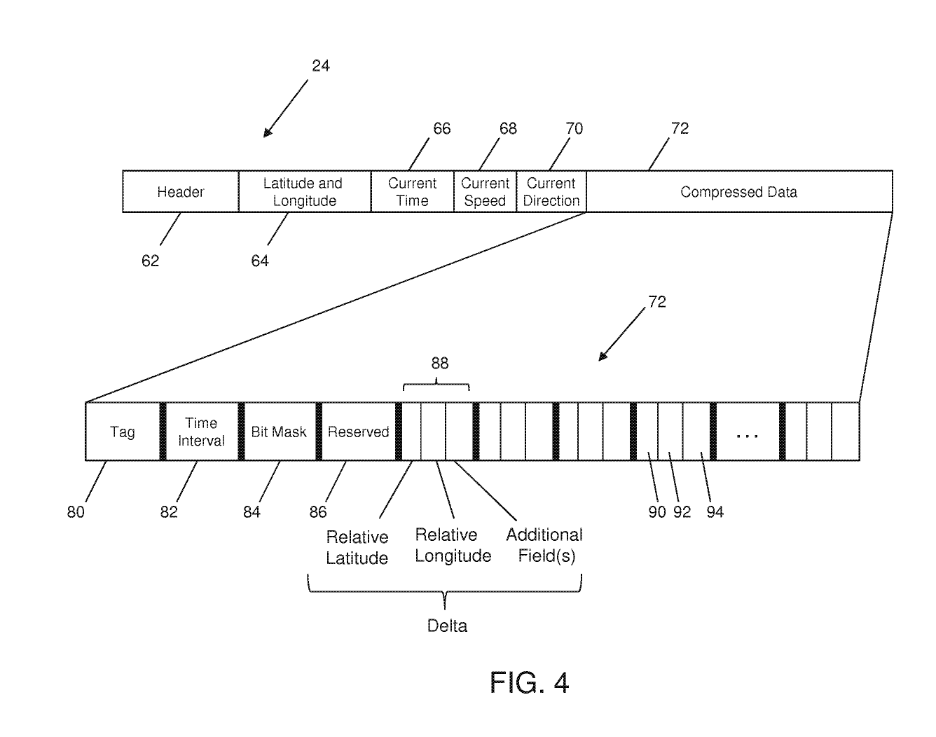

Turning now to FIG. 4, an example of a data structure for a location packet 24. The location packet includes a header field 62, and a full (i.e. uncompressed) latitude and longitude field 64 for providing an initial GPS location. The packet 24 also includes a current time field 66, which corresponds to the initial GPS location; a current speed field 68, which corresponds to the speed of the vehicle 14 when the initial GPS location was determined; and a current direction field 70, which corresponds to the direction of travel of the vehicle 14 at the time the initial GPS location was determined. The remaining data in the location packet 72 is a set of compressed data 72, which is shown in greater detail in the enlarged portion of FIG. 4.

The compressed data 72 includes a tag field 80 to identify the subsequent data as being compressed data generated according to the present compression technique. The compressed data 72 also includes a time interval field 82 to specify the time interval used for successive relative GPS readings. An optional bit mask field 84 can also be included to specify whether other data is included in the location packet 24. A reserved field 86 can also be included to allow for application-specific information such as the status of input/output (I/O) ports to be included in the packet 24.

Beyond the reserved field 86 is a series of relative GPS updates 88, which are compressed as described below. Each relative GPS update 88 includes a relative latitude value 90, a relative longitude value 92, and an additional field 94. The additional field 94 can also be used for including application-specific information.

By having the initial latitude and longitude 64 and the time interval 82, the relative GPS updates 88, which have been compressed, can be used to decode a series of GPS updates 88 that can be stored by the location tracking system 16 in the location history database 54 and/or used to update a user interface 56. Since the GPS updates 88 are compressed, a higher number of location updates can be included in a single location packet 24 therefore providing better granularity within each update. This can be particularly important for vehicle fleet tracking in which movements within a 5 minute interval could be valuable (i.e. important movements could be unaccounted for otherwise).

An example structure of a location packet 24 illustrating exemplary field length values suitable for use on a commercial radio network is as follows in Table 1. The length of each field is dependent on the encoding scheme used and the amount of overhead required.

TABLE 1
Example Location Packet Field Lengths

| Field | Length (Bytes) |
|---|---|
| Packet Header | Implementation Specific |
| Full latitude and longitude | 8 |
| Current time | 4 |
| Current Speed | 4 |
| Current Direction | 1 |
| Compressed Data | Detailed Below in Table 2 |

The structure of the compressed data 72 is exemplified as follows:

TABLE 2
Example compressed data field lengths

| Field | Length (Bits) |
|---|---|
| Tag specifying that the following data is | 8 |
| compressed | |
| Time Interval | 3 |
| Additional Field Bit-mask | 5 |
| Reserved Byte | 8 |

The following fields are repeated in this order up to the maximum allowable in the particular application, to provide the relative GPS updates 88:

TABLE 3
Example relative GPS update field lengths

| | |
|---|---|
| Relative Latitude | 16 |
| Relative Longitude | 16 |
| Additional Fields | Implementation Specific |

The time interval is determined according to the following table:

TABLE 4
Example time interval look up table

| Value | Time (seconds) |
|---|---|
| 0 | 5 |
| 1 | 10 |
| 2 | 15 |
| 3 | 20 |
| 4 | 30 |
| 5 | 60 |

The optional bit fields are described in the bit mask as such:

TABLE 5
Example bit mask fields

| Value | Optional Field |
|---|---|
| 00000 | No Optional Fields |
| XXXX1 | Speed |
| XXX1X | Direction |
| XX1XX | Time |
| X1XXX | Reserved |
| 1XXXX | Reserved |

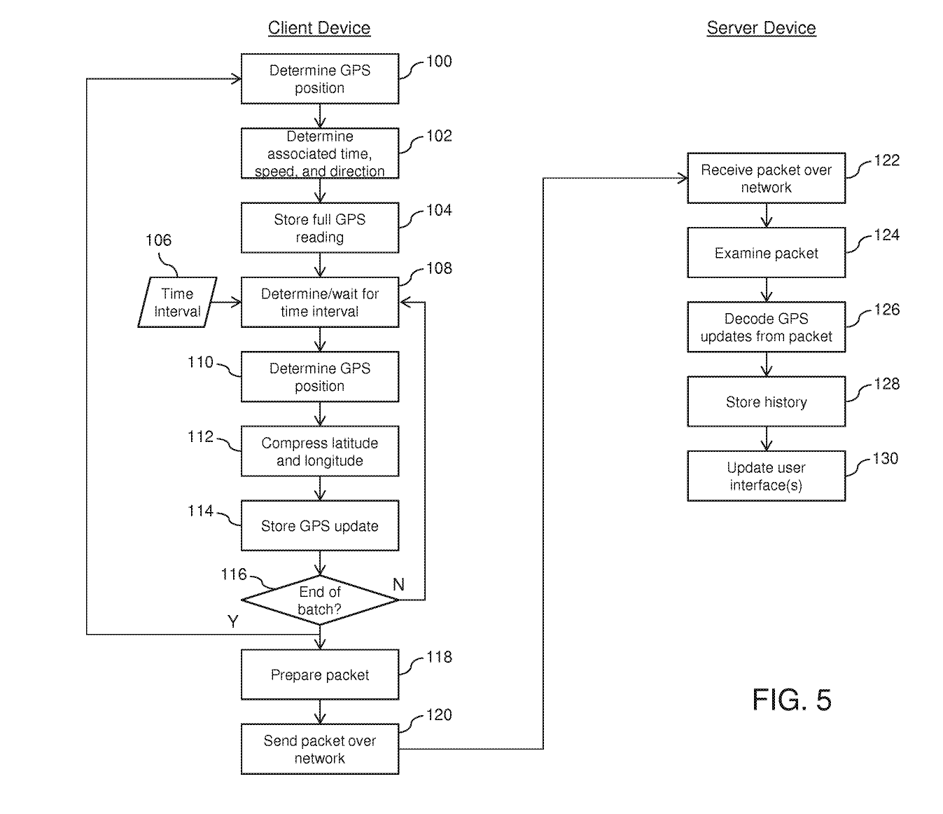

Turning now to FIG. 5, shown is an example process for generating and sending a location packet 24 from a location tracking device 12 to the location tracking system 16. At 100 the location tracking device 12 uses the GPS receiver 42 to determine the initial GPS location to be stored in the latitude and longitude field 64. The associated time, speed and direction are then determined at 102 in order to be able to populate the fields 66-70. The full GPS reading and associated data are then stored at 104 and based on a particular time interval value 106 (e.g., 5 seconds—selected or predetermined), the location tracking client application 40 determines the time interval value 106 to populate the time interval field 82. The time interval value 106 is also used to determine when the next GPS location is to be computed to generate the next relative GPS update 88. The GPS position is determined at 110, and the latitude and longitude values for that position are compressed at 112 to generate the GPS update 88 to be stored at 114. Each packet 24 includes a “batch” of GPS updates 88 and the location tracking client application 40 determines at 116 if it is at the end of the batch, i.e. if the packet 24 is complete. If not, the next GPS update 88 is generated according to the time interval 106. Once the end of the batch is reached, the location packet 24 is prepared at 118 and sent over the network 26 at 120.

The location tracking system 16 receives the packet 24 over the network 26 at 122 and examines the packet 24 at 124, e.g., to determine the time interval 106, initial GPS position, etc. The packet 24 is decoded to use the relative GPS updates 88 to generate a series of GPS positions beginning with the initial GPS position stored in the latitude and longitude field 64. The series of GPS positions can then be stored in an associated history for the corresponding vehicle 14 and, if applicable, an administrator user interface can be updated at 130 (e.g., to display a periodic “current” location.

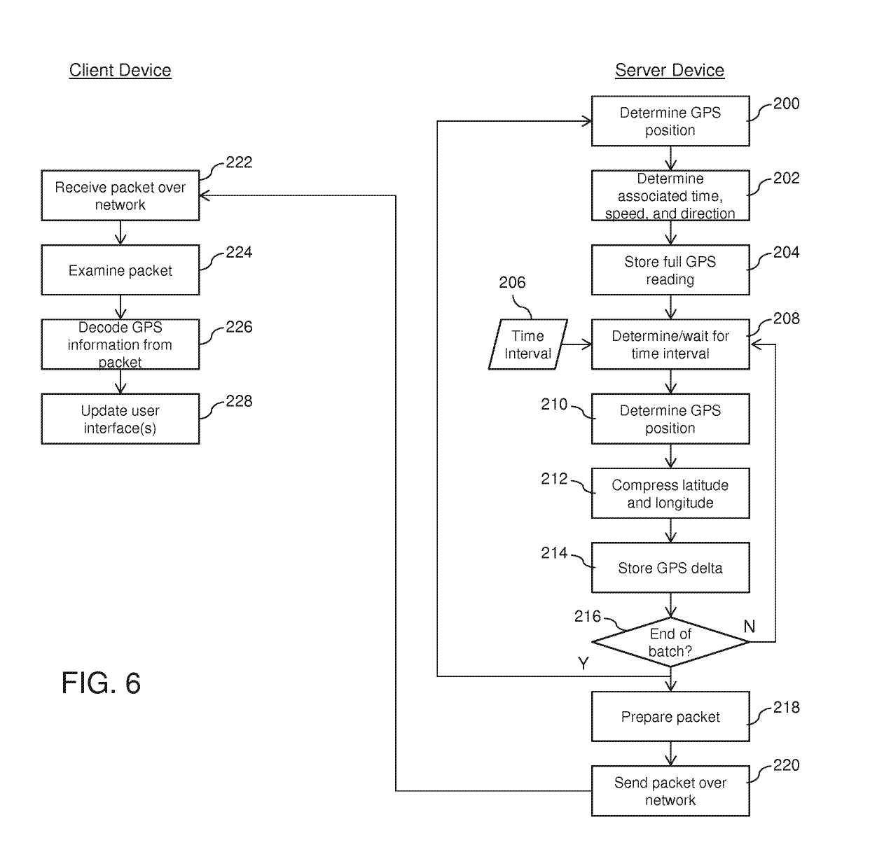

FIG. 6 illustrates the compression of a series of GPS readings for an object or device to generate a location packet 24 to send to the location tracking device 12. At 200 the location tracking system 16 or 3^{rd} party location based service 28 uses available GPS coordinates to determine an initial GPS location to be stored in the latitude and longitude field 64. The associated time, speed and direction are then determined at 202 in order to be able to populate the fields 66-70. The full GPS reading and associated data are then stored at 204 and based on a particular time interval 206 (e.g., 5 seconds—selected or predetermined), the location tracking server application 50 determines the time interval value to populate the time interval field 82. The time interval 206 is also used to determine when the next GPS location is to be computed to generate the next relative GPS update 88. The GPS position is determined at 210, and the latitude and longitude values for that position are compressed at 212 to generate the GPS update 88 to be stored at 214. Each packet 24 includes a “batch” of GPS updates 88 and the location tracking server application 50 determines at 216 if it is at the end of the batch, i.e. if the packet 24 is complete. If not, the next GPS update 88 is generated according to the time interval 206. Once the end of the batch is reached, the location packet 24 is prepared at 218 and sent over the network 26 at 220.

The location tracking device 12 receives the location packet 24 over the network 26 at 222 and examines the packet at 224, e.g., to determine the interval 206 etc. The location tracking client application 40 may then decode the location packet 24 to determine the successive GPS updates 88 at 226, e.g. to update a user interface at 228.

It can be appreciated from FIG. 6 that the compression technique described herein can be used to reduce the bandwidth requirements and/or to improve the granularity of any set of GPS updates, e.g., can be used bi-directionally in the system 10 or other systems which track the location of objects.

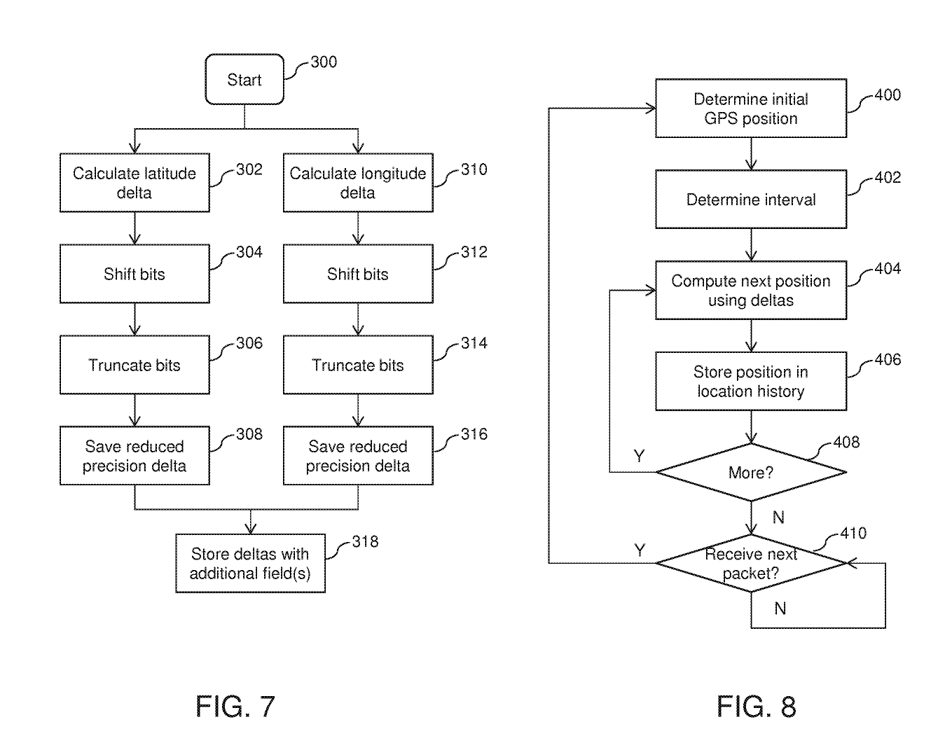

In the present example, the values for relative latitude 90 and relative longitude 92 can be calculated as shown in FIG. 7 (e.g., for steps 112, 212). The compression routine begins at 300 and the latitude value is compressed first, by way of example only. At 302 a latitude delta is calculated using the formula: Pᵣₑₗₐₜᵢᵥₑ=P_{current}−Pₚᵣₑᵥᵢₒᵤₛ. The resulting delta is bit shifted by two places to the right at 304. A truncation is then performed at 306, in this example saving only the first (i.e. least significant) 16 bits. A reduced precision delta for latitude is thus saved at 308. The process repeats for longitude by calculating the longitude delta at 310 using the above formula, shifting the bits at 312 and truncating the bits at 314 to save a reduced precision delta (16 bits) at 316. The deltas 90, 92 are then stored with the additional field 94 as the next relative GPS update 88 at 318. By reducing all but the initial GPS position from 64 bits to 32 bits, a significant amount of bandwidth can be saved.

At the recipient end, the initial GPS location is determined at 400 using the latitude and longitude field 64. The time interval is then determined using the time interval field 82 and the next GPS position is computed at 404 using the deltas 90, 92 from the next relative GPS update 88. The values for latitude and longitude are calculated using the formula Pᵣₑₗₐₜᵢᵥₑ=P_{current}−Pₚᵣₑᵥᵢₒᵤₛ. The magnitude of this value is stored as 16 bits, then shifted right once at 304 to remove the least significant bit at 306. The sign is placed in the most significant bit. In the event that this signed 16 bit value overflows or there is a loss of GPS signal, the sequence of relative calculations is restarted with a new compressed tag. The shifting operation means that the smallest and largest values are twice what the original GPS provides, this is considered a good tradeoff because the maximum speed traveled in a given time interval is more important than sub 1 meter positioning. The next GPS position is stored in the location history at 406. The location tracking server application 50 determines at 408 if there are more relative GPS positions. If so, the next GPS position is computed by repeating 404 and 406. If not, the receiver waits until it determines at 410 that a next location packet 24 has been received, at which time the next batch of location updates is decoded.

In the example described herein, some constraints may be imposed. It can be appreciated that the following exemplary constraints shown in Table 6, may only apply to a particular example and the principles described herein can be applied outside of these constraints in other applications.

TABLE 6
Example Application-Specific Constraints

| Constraint | Limit |
|---|---|
| Minimum time interval | 5 seconds |
| Maximum Latitude | 67N |
| Minimum Latitude | 67S |
| Maximum Velocity @67N/S | 170 km/h |
| Maximum Distance Travelled per Time Interval | 235 m |
| @67N/S | |
| Maximum Records per Packet | 105 |

The above constraints apply to a moving object such as a truck or car within the target sales area of the applicants' current business. Different constraints would apply to objects travelling at higher or very slow velocities as an example.

A compression technique is therefore provided that uses time, latitude, and longitude information to create a data structure that contains an array of latitude and longitude information from which unnecessary levels of latitude and longitude precision have been removed and all time has been removed. The data structure is formatted in such a way that time information associated with each latitude and longitude informational element can be determined by its location in said data structure, such that the data structure contains of all of the latitude and longitude information originally applied to the algorithm at a reduced fidelity, yet of sufficient precision to be useful for determining changes in latitude and longitude information over time.

Constraints and limitations may be applicable in some applications as noted above, such as maximum and minimum values of latitude and a maximum total change in latitude, longitude, or both over a predetermined and fixed time period, such that the resulting data structure contains sufficient information so that latitude and longitude values remain useful, while doing so with a reduced total storage size for all data relative to the original latitude, longitude, and time information so as to maximize informational throughput on low bandwidth packet switched networks.

There is also provided a decompression algorithm for the data structure resulting from the above compression algorithm that is able to convert the compressed time, latitude, and longitude information from relative time, latitude, and longitude information to absolute time, latitude, and longitude information; such that the resulting uncompressed time, latitude, and longitude information may be used independently of the other time, latitude, and longitude information contained in the data structure created by said compression algorithm.

The system described herein presents a unique lossy compression algorithm for GPS information by calculating the deltas between series of GPS locations and reducing the accuracy of the GPS information to obtain greater throughput on low bandwidth wireless networks.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the location tracking device 12, vehicle 14, location tracking system 16, 3^{rd} party location based service 28, any component of or related to such entities, or accessible or connectable thereto. Any application or module herein described may be implemented using computer readable/executable instructions that may be stored or otherwise held by such computer readable media.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of compressing global positioning system (GPS) data, the method comprising:
determining a first GPS position and an associated first time;
incorporating the first GPS position and the associated first time in a GPS update packet;
determining a time interval for a set of GPS positions subsequent to the first GPS position and specifying the time interval in the GPS update packet; and
for each of the set of GPS positions subsequent to the first GPS position:
computing a relative latitude value and a relative longitude value;
compressing the relative latitude and longitude values by reducing precision; and
storing compressed relative latitude and longitude values in the GPS update packet.

2. The method of claim 1, further comprising storing at least one of a current speed value and a current direction value in the GPS update packet.

3. The method of claim 1, further comprising incorporating a tag specifying that the subsequent data corresponding to the set of GPS positions has been compressed.

4. The method of claim 1, further comprising incorporating a bit mask specifying whether or not one or more optional fields in the GPS update packet have been utilized.

5. The method of claim 1, wherein reducing the precision comprises shifting and truncating bits in each of the relative latitude and longitude values.

6. The method of claim 1, wherein the time interval is selected from one of a plurality of possible time intervals, the method further comprising incorporating a look-up value in the GPS update packet representative of the time interval.

7. The method of claim 1, wherein the GPS update packet is generated by a location tracking device associated with a moving object, and sent to a location tracking system over a network.

8. The method of claim 1, wherein the GPS update packet is generated by a location tracking system or a third party location based service and sent to a location tracking device associated with a moving object.

9. A computer readable medium comprising computer executable instructions for compressing global positioning system (GPS) data, the computer executable instructions comprising instructions for:
determining a first GPS position and an associated first time;
incorporating the first GPS position and the associated first time in a GPS update packet;
determining a time interval for a set of GPS positions subsequent to the first GPS position and specifying the time interval in the GPS update packet; and
for each of the set of GPS positions subsequent to the first GPS position:
computing a relative latitude value and a relative longitude value;
compressing the relative latitude and longitude values by reducing precision; and
storing compressed relative latitude and longitude values in the GPS update packet.

10. A system for compressing global positioning system (GPS) data, the system comprising a processor and memory, the memory comprising computer executable instruction executable to:
determine a first GPS position and an associated first time;
incorporate the first GPS position and the associated first time in a GPS update packet;
determine a time interval for a set of GPS positions subsequent to the first GPS position and specifying the time interval in the GPS update packet; and
for each of the set of GPS positions subsequent to the first GPS position:
compute a relative latitude value and a relative longitude value;
compress the relative latitude and longitude values by reducing precision; and
store compressed relative latitude and longitude values in the GPS update packet.

11. A method of decompressing compressed global positioning system (GPS) data, the method comprising:
receiving a GPS update packet, the GPS update packet comprising a first GPS position, an associated first time, a time interval, and a set of GPS positions subsequent to the first GPS position, each of the set of GPS positions subsequent to the first GPS position comprising a relative latitude value and a relative longitude value, the relative latitude and longitude values having been compressed by reducing precision; and
for each of the set of GPS positions subsequent to the first GPS position:
computing a full GPS positions using the relative latitude and longitude values and a previous GPS position; and
associating a time with the full GPS positions according to the time interval.

12. The method of claim 11, wherein the GPS update packet stores at least one of a current speed value and a current direction value.

13. The method of claim 11, wherein the GPS update packet incorporates a tag specifying that the subsequent data corresponding to the set of GPS positions has been compressed.

14. The method of claim 11, wherein the GPS update packet incorporates a bit mask specifying whether or not one or more optional fields in the GPS update packet have been utilized.

15. The method of claim 11, wherein reducing the precision comprises shifting and truncating bits in each of the relative latitude and longitude values.

16. The method of claim 11, wherein the time interval has been selected from one of a plurality of possible time intervals, the method further comprising referencing a look-up value in the GPS update packet to determine the time interval.

17. The method of claim 11, wherein the GPS update packet has been generated by a location tracking device associated with a moving object, and received by a location tracking system over a network.

18. The method of claim 11, wherein the GPS update packet has been generated by a location tracking system or a third party location based service and is received by a location tracking device associated with a moving object.

19. A computer readable medium comprising computer executable instructions for decompressing global positioning system (GPS) data, the computer executable instructions comprising instructions for:
receiving a GPS update packet, the GPS update packet comprising a first GPS position, an associated first time, a time interval, and a set of GPS positions subsequent to the first GPS position, each of the set of GPS positions subsequent to the first GPS position comprising a relative latitude value and a relative longitude value, the relative latitude and longitude values having been compressed by reducing precision; and
for each of the set of GPS positions subsequent to the first GPS position:
computing a full GPS positions using the relative latitude and longitude values and a previous GPS position; and
associating a time with the full GPS positions according to the time interval.

20. A system for decompressing global positioning system (GPS) data, the system comprising a processor and memory, the memory comprising computer executable instruction executable to:
receive a GPS update packet, the GPS update packet comprising a first GPS position, an associated first time, a time interval, and a set of GPS positions subsequent to the first GPS position, each of the set of GPS positions subsequent to the first GPS position comprising a relative latitude value and a relative longitude value, the relative latitude and longitude values having been compressed by reducing precision; and
for each of the set of GPS positions subsequent to the first GPS position:
compute a full GPS positions using the relative latitude and longitude values and a previous GPS position; and
associate a time with the full GPS positions according to the time interval.
